(19) United States
(12) Patent Application Publication
(10) Pub. No.: US 2018/0034410 A1
(43) Pub. Date: Feb. 1, 2018

(54) PHOTOVOLTAIC POWER GENERATION SYSTEM EVALUATION APPARATUS, EVALUATION METHOD, AND STORAGE MEDIUM STORING A PROGRAM FOR AN EVALUATION APPARATUS

(71) Applicants: National Institute of Advanced Industrial Science and Technology, Tokyo (JP); KYOSHIN ELECTRIC CO., LTD., Kyoto-shi (JP)

(72) Inventors: Yoshihiro Hishikawa, Tsukuba-shi (JP); Hisashi Kojima, Kyoto-shi (JP); Yuji Fujita, Otsu-shi (JP); Yoshikazu Takeda, Kyoto-shi (JP)

(21) Appl. No.: 15/410,689

(22) Filed: Jan. 19, 2017

(30) Foreign Application Priority Data
Jul. 29, 2016 (JP) 2016-150436

(51) Int. Cl. H02S 50/10; H02J 3/38

(52) U.S. Cl. CPC H02S 50/10; H02J 3/385

(57) ABSTRACT

In order to provide an evaluation apparatus that is capable of measuring the performance of a photovoltaic power generation system accurately while using simple equipment outdoors using sunlight, there are provided a plurality of illumination intensity sensors disposed in the vicinity of the photovoltaic panels, and an evaluator that is connected to a PCS and to the sensors, and evaluates the performance of the photovoltaic power generation system based on outputs from each of these, and the evaluator includes an output acquisition unit that acquires an output of the photovoltaic panels from the PCS, a consistency degree calculation unit that calculates a degree of consistency in illumination intensity measurement values measured by the sensors, and a determination unit that, when the degree of consistency is within a predetermined permissible range, determines that the output of the photovoltaic panels acquired by the output acquisition unit is a true value.

### TECHNICAL FIELD

The present invention relates to a photovoltaic power generation system evaluation apparatus that is used to evaluate a performance of an outdoor photovoltaic power generation system, to an evaluation method, and to a storage medium on which a program for an evaluation apparatus is stored.

### TECHNICAL BACKGROUND

When evaluating the performance of a photovoltaic cell or a photovoltaic panel that is configured by a plurality of photovoltaic cells, the I-V characteristics are measured and the performance is then evaluated based on the results of this measurement.

The I-V characteristics of a photovoltaic cell are changed considerably by the illumination intensity of the light that is irradiated onto the photovoltaic cell as is shown, for example, in the measurement results in Patent document 1. Because of this, the measurement of the I-V characteristics is conducted such that the illumination intensity of the light irradiated onto a photovoltaic cell by a solar simulator during an indoor measurement is held at 1 sun. In this way, the I-V characteristics measured at an illumination intensity of 1 sun are treated as the I-V characteristics of a photovoltaic cell under standard test conditions.

In contrast, it is difficult to bring indoors a large-scale photovoltaic power generation system that is used outdoors and is configured by a photovoltaic panel or by combining a plurality of photovoltaic panels, and to irradiate light uniformly onto the entire surface of each photovoltaic panel using a solar simulator. Because of this, measurement of the I-V characteristics is conducted outdoors using sunlight.

However, the illumination intensity of sunlight can vary greatly within even a short space of time, so that the I-V characteristics are often not measured in 1 sun conditions. Because of this, in many cases, a value obtained by averaging the results measured for the I-V characteristics over, for example, a one-month period is substituted as a value showing the performance of a photovoltaic power generation system.

Accordingly, compared with an accurate performance evaluation of a photovoltaic cell that is measured indoors with illumination intensity conditions stabilized at 1 sun, the performance evaluation of a photovoltaic power generation system measured outdoors ends up being inaccurate due to the fact that it is largely impossible to stabilize the illumination intensity. Moreover, it is difficult currently to accurately evaluate which photovoltaic power generation systems actually exhibit a superior performance, or whether or not some type of malfunction has occurred, or the like.

Furthermore, when attempting to accurately measure the I-V characteristics for a photovoltaic power generation system, it is necessary to firstly halt power generation and to then sweep the current during the extremely short time when there is no change in the amount of solar radiation. Accordingly, the problem exists that a great deal of time and labor is required in order to perform such measurements.

### DOCUMENTS OF THE PRIOR ART

### Patent Documents

Patent document 1

Japanese Unexamined Patent Application (JP-A) No. 2004-281480

### DISCLOSURE OF THE INVENTION

### Problems to be Solved by the Invention

The present invention was conceived in order to solve the above-described issues, and it is an object thereof to provide a photovoltaic power generation system evaluation apparatus that is capable of measuring the performance of a photovoltaic power generation system accurately and using simple equipment even when this measurement is performed outdoors using sunlight, and to also provide an evaluation method, and a storage medium on which a program for an evaluation apparatus is stored.

### Means for Solving the Problem

Namely, the present invention was achieved for the first time when the inventors of the present application discovered as a result of strenuous investigations that, even in weather conditions without bright sunlight, there are cases in which the illumination intensity of sunlight (i.e., the amount of solar radiation) is sufficiently stable for the performance of a photovoltaic power generation system to be evaluated without any problem, and there is only low-level unevenness of the illumination intensity within the photovoltaic panels and within the photovoltaic system, and discovered conditions in which this performance can be accurately evaluated even in weather without bright sunlight. Moreover, the present invention was able to be achieved when the inventors of the present application also discovered that, in addition to the aforementioned discovery, if they skillfully utilized the equipment provided in a photovoltaic power generation system, then it is possible to accurately evaluate the performance thereof without the need to measure the I-V characteristics.

More specifically, the photovoltaic power generation system evaluation apparatus according to the present invention is a photovoltaic power generation system evaluation apparatus that evaluates a performance of a photovoltaic power generation system that comprises photovoltaic panels which are configured by a plurality of photovoltaic cells, and a PCS (Power Control System) that is connected to the photovoltaic panels and performs MPPT (Maximum Power Point Tracking) control, and includes a plurality of illumination intensity sensors that are disposed in the vicinity of the photovoltaic panels, and an evaluator that is connected either wirelessly or by wires to the PCS and to the plurality of illumination intensity sensors, and evaluates the performance of the photovoltaic power generation system based on outputs from each of the PCS and the plurality of illumination intensity sensors, wherein the evaluator is provided with an output acquisition unit that acquires an output of the photovoltaic panels from the PCS, a consistency degree calculation unit that calculates a degree of consistency in illumination intensity measurement values measured by the plurality of illumination intensity sensors, and a determination unit that, when the degree of consistency is within a predetermined permissible range, determines that the output of the photovoltaic panels acquired by the output acquisition unit is a true value.

Here, MPPT control refers to a control method that operates while tracking an optimum operating point that varies constantly due to changes in weather conditions and the like. For example, using an algorithm such as the hill-climbing method, output is continued at the optimum operating point of the output of the photovoltaic panels irrespective of the weather conditions.

If this type of structure is employed, then because the output acquisition unit acquires the output of the photovoltaic panel from the PCS performing the MPPT control, it is possible to always acquire the output at the optimum operating point. Furthermore, the illumination intensity measurement values measured by the respective individual illumination intensity sensors exhibit substantially the same values, and there is no unevenness in the illumination intensity of the sunlight (i.e., in the solar radiation amount) that is irradiated onto the photovoltaic panel being measured. Accordingly, it is determined by the determination unit that only an output measured in a stabilized state provides true values.

Namely, when the illumination intensity of the sunlight varies considerably, or when the illumination intensity differs greatly depending on the location on the photovoltaic panel being measured, then the output at such times is not regarded as the proper output that that particular photovoltaic panel is capable of outputting and is not employed. Only the output measured at an accuracy which is substantially equivalent to when the photovoltaic panel is in bright sunlight, even if there are variations in amount of solar radiation, can be employed as the proper output of that particular photovoltaic panel. Namely, according to the present invention, it is possible to find the maximum operating point of a photovoltaic power generation system without measuring the I-V characteristics, and an accurate performance evaluation of a photovoltaic power generation system can be achieved using only a simple measurement device.

Moreover, because measuring the output from a photovoltaic power generation system with a high degree of accuracy becomes possible using sunlight even when the weather is not bright sunshine and there are variations in the amount of solar radiation, the prerequisite weather conditions become more flexible so that sufficient measurement opportunities are obtainable.

In order to make it possible to capture the instant when the illumination intensity achieves sufficient uniformity to enable performance evaluation to be performed over the entire photovoltaic panel surface area even in a large-scale photovoltaic power generation system, while also making it possible to eliminate the task of laying wiring and the like for this, it is also sufficient if the illumination intensity sensors are provided with a plurality of photovoltaic cells, and a wireless communicator that wirelessly transmits at least a portion of the outputs from the plurality of photovoltaic cells to the evaluator. If this type of structure is employed, then it becomes possible for the illumination intensity sensors themselves to supply the power required to measure the current illumination intensity and to transmit the data relating to the illumination intensity to the evaluator using the output from the photovoltaic cells.

In order to make it possible to determine using simple calculations whether or not sunlight is being irradiated uniformly over the entire photovoltaic panel surface area, and whether or not, for example, predetermined conditions that make performance evaluation possible are in effect, it is sufficient if the consistency degree calculation unit is configured such that it calculates as the degree of consistency an illumination intensity difference, which is a difference in the illumination intensity measurement values measured by the plurality of illumination intensity sensors, and if the determination unit is configured such that it determines that an output of the photovoltaic panels acquired by the output acquisition unit is a true value when the illumination intensity difference is not more than a predetermined permissible difference.

In order to make it possible for unevenness in the illumination intensity on the photovoltaic panels being measured that are due to changes in the weather to be accurately detected from the illumination intensity measurement values measured by the plurality of illumination intensity sensors, and to thereby improve the accuracy of determinations made by the determination unit, it is sufficient to employ a structure in which a sampling time of the plurality of illumination intensity sensors is set to not more than 100 milliseconds, and the illumination intensity measurements made by each of the illumination intensity sensors are temporally synchronized. If this type of structure is employed, then it becomes possible to satisfactorily ascertain changes in the illumination intensity of sunlight using the illumination intensity sensors, and to make it so that there is no offset between the timings of the measurements made by the respective illumination intensity sensors, and so that only the effects of the illumination intensity unevenness are represented in the degree of consistency.

In order to enable the illumination intensity measurement values to be used not only to determine whether or not any unevenness in the illumination intensity exists in the illumination intensity measurement values measured by the plurality of illumination intensity sensors, but also to correct with a high level of accuracy the effects brought about by variations in the illumination intensity of the sunlight during the measurement of the output, it is sufficient if a sampling time of the plurality of illumination intensity sensors is set to not less than 1 millisecond and not more than 100 milliseconds.

In order to enable the power generated at the maximum operating point to be accurately measured as the output of the photovoltaic panels, it is sufficient if the output acquisition unit is configured by an ammeter and a voltmeter that are provided in the PCS.

If a photovoltaic power generation system evaluation method for evaluating the performance of a photovoltaic power generation system that comprises photovoltaic panels that are configured by a plurality of photovoltaic cells, and a PCS that is connected to the photovoltaic panels and performs MPPT control, and that includes an illumination intensity acquisition step in which respective illumination intensities are acquired by a plurality of illumination intensity sensors that are disposed in the vicinity of the photovoltaic panels, an output acquisition step in which an output of the photovoltaic panels is acquired from the PCS, a consistency degree calculation step in which a degree of consistency in illumination intensity measurement values measured by the plurality of illumination intensity sensors is calculated, and a determination step in which, when the degree of consistency is within a predetermined permissible range, it is determined that the output of the photovoltaic panels acquired in the output acquisition step is a true value, is employed, then it becomes possible to accurately evaluate the performance of an outdoor photovoltaic power generation system using sunlight without having to perform I-V measurement.

If a storage medium storing a program for a photovoltaic power generation system evaluation apparatus wherein the program is used in a photovoltaic power generation system evaluation apparatus that evaluates a performance of a photovoltaic power generation system that comprises photovoltaic panels which are configured by a plurality of photovoltaic cells, and a PCS which is connected to the photovoltaic panels and performs MPPT control, and that is provided with: a plurality of illumination intensity sensors that are disposed in the vicinity of the photovoltaic panels; and an evaluator that is connected either wirelessly or via wires to the PCS and to the plurality of illumination intensity sensors, and evaluates the performance of the photovoltaic power generation system based on outputs from each of the PCS and the plurality of illumination intensity sensors, and wherein the program causes functions of a consistency degree calculation unit that calculates a degree of consistency in illumination intensity measurement values measured by the plurality of illumination intensity sensors; and functions of a determination unit that, when the degree of consistency is within a predetermined permissible range, determines that the output of the photovoltaic panels acquired by the output acquisition unit is a true value to be performed by a computer is employed, then it becomes possible to discover a point in time when sunlight is being irradiated uniformly over an entire photovoltaic panel surface, and unevenness in the illumination intensity is sufficiently small, and to acquire the output from the photovoltaic panels at this time as the output at the maximum operating point. Note that the storage medium on which the program for a photovoltaic power generation system evaluation apparatus is stored may take the form of a variety of storage mediums such as a CD, DVD, HDD, or flash memory or the like.

### Effects of the Invention

In this manner, according to the photovoltaic power generation system evaluation apparatus of the present invention, because a structure is employed in which a plurality of illumination intensity sensors are provided, and it is determined by the output acquisition unit that the output obtained from the PCS is a true value when the degree of consistency of the illumination intensity as measured by each illumination intensity sensor is within an permissible range, it is possible to selectively employ only data in which the illumination intensity of the sunlight (i.e., the amount of solar radiation) is stable, and sunlight is irradiated substantially uniformly over the entire photovoltaic panel so that the proper output is accurately reflected.

Conventionally it has not been possible to accurately evaluate the proper characteristics because an average of data relating to a number of outputs has been taken while considering changes in the illumination intensity. However, according to the photovoltaic power generation system according to the present invention, it has become possible to make accurate evaluations.

Moreover, because it is not necessary to perform current sweeping on a photovoltaic panel, as is the case when I-V characteristics are being measured, the structure of the measurement device can be simplified, and accurate evaluations can be made simply by attaching this measurement device to existing equipment.

### BRIEF DESCRIPTION OF THE DRAWINGS

FIG. 1 is a schematic view showing a photovoltaic power generation system evaluation apparatus according to an embodiment of the present invention.

FIG. 2 is a schematic perspective view showing an exterior of an illumination intensity sensor according to the same embodiment.

FIG. 3 is a schematic functional block diagram of a photovoltaic power generation system evaluation apparatus according to the same embodiment.

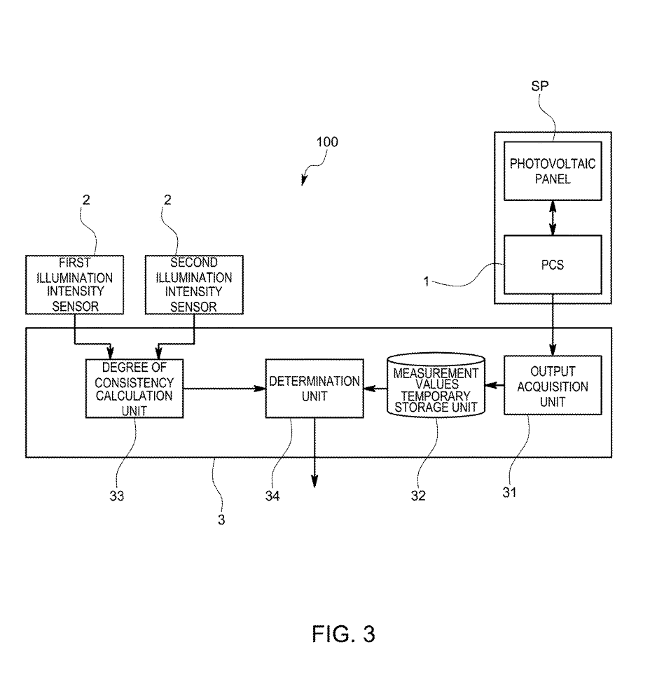

FIG. 4 shows a comparison between the response rates of the illumination intensity sensor according to the same embodiment and a pyrheliometer and high-speed pyrheliometer.

### BEST EMBODIMENTS FOR IMPLEMENTING THE INVENTION

A photovoltaic power generation system evaluation apparatus 100 according to an embodiment of the present invention will now be described with reference made to the respective drawings.

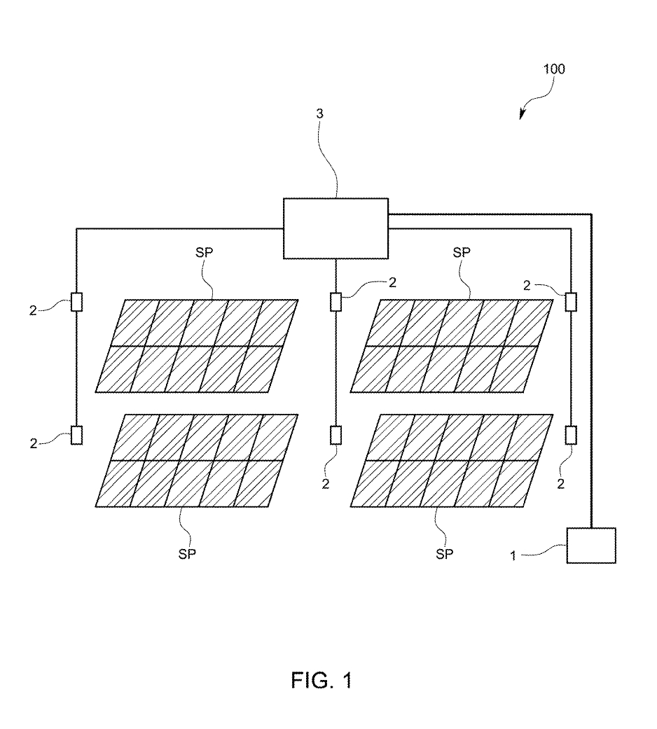

The photovoltaic power generation system evaluation apparatus 100 of the present embodiment is used to evaluate characteristics of a photovoltaic power generation system that, as is shown in FIG. 1, is provided with photovoltaic panels SP that are configured by a plurality of photovoltaic cells, and a PCS (Power Control System) 1 that controls operations of the photovoltaic panels SP using MPPT control. More specifically, the photovoltaic power generation system evaluation apparatus 100 performs performance evaluation outdoors based on the assumption that power generation is performed in such a way that the photovoltaic power generation system tracks the maximum operating point even when there are changes in the illumination intensity of the sunlight.

Namely, as is shown in FIG. 1, the photovoltaic power generation system evaluation apparatus 100 is provided with a plurality of illumination intensity sensors 2 that are disposed around the periphery of the photovoltaic panels SP, and an evaluator 3 that evaluates the performance of the photovoltaic power generation system based on output from each of the illumination intensity sensors 2, and on information acquired by the PCS 1.

An illumination intensity sensor 2 is provided, for example, in the vicinity of each photovoltaic panel SP, and the illumination intensity sensors 2 are arranged such that the illumination intensity on each photovoltaic cell forming the photovoltaic panels SP can be measured or estimated based on outputs and positional relationships between the respective illumination intensity sensors 2. Namely, the illumination intensity of sunlight between the illumination intensity sensors 2 can be calculated at a predetermined accuracy using arithmetic mean values or proportional calculation or the like. Note that six illumination intensity sensors 2 are shown in FIG. 1, however, in order to simplify the following description, when the description distinguishes between illumination intensity sensors 2 that have been installed in different locations, these are referred to as a first illumination intensity sensor 2 and a second illumination intensity sensor 2.

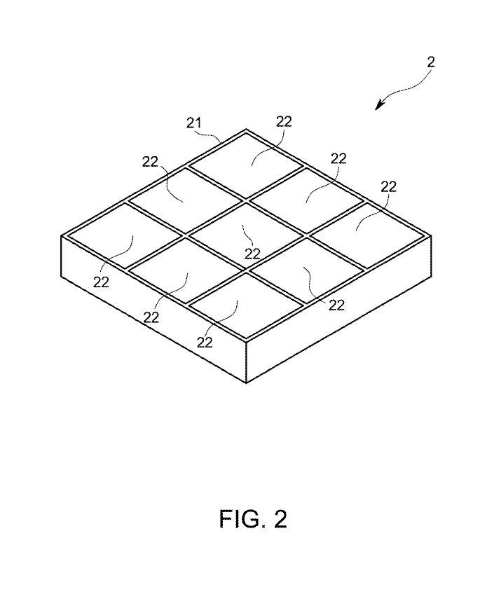

As is shown in FIG. 2, in the illumination intensity sensors 2, nine photovoltaic cells 22 are exposed on a surface of a rectangular parallelepiped-shaped casing 21 in an array pattern. Moreover, the illumination intensity sensors 2 are provided with a wireless communicator (not shown in the drawings) that is constructed such that outputs from the photovoltaic cells 22 are transmitted as data to the evaluator 3 via wireless communication between the illumination intensity sensors 2 and the evaluator 3. Of the nine photovoltaic cells 22 in this illumination intensity sensor 2, the photovoltaic cell 22 in the central portion is used for calculating the illumination intensity by converting the amount of power generation therefrom into an illumination intensity, while the remaining eight photovoltaic cells 22 supply power for driving the wireless communicator and the like.

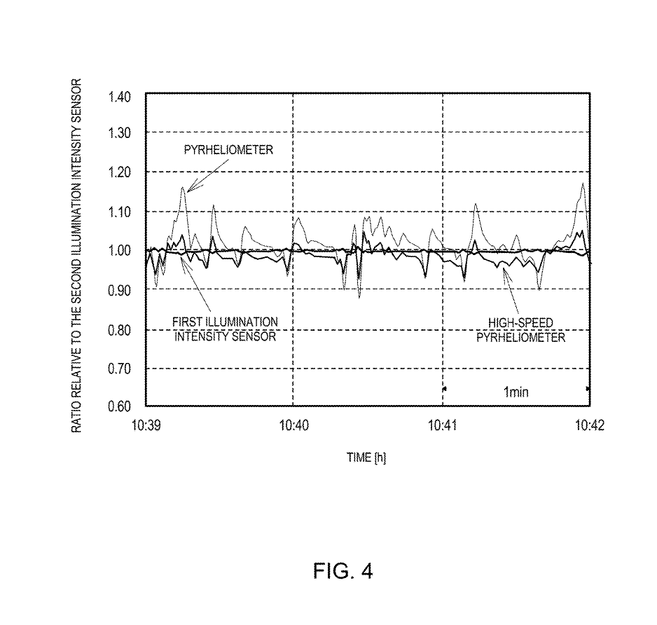

The illumination intensity sensors 2 that use the photovoltaic cells 22 in this manner are disposed at substantially the same angle of inclination as the angle of inclination of the photovoltaic panels SP, and are set up in substantially the same state of alignment as the photovoltaic panels SP. Moreover, ratios of the outputs from a pyrheliometer, a high-speed pyrheliometer, and the first illumination intensity sensor 2 of the present embodiment relative to an output from the second illumination intensity sensor 2 (essentially, the output that can also be treated as the output from the photovoltaic panel SP) are shown in the graph in FIG. 4. As can be understood from the graph in FIG. 4, compared to a pyrheliometer and a high-speed pyrheliometer that are used in normal outdoor measurements, the first illumination intensity sensor 2 of the present embodiment tracks the output from the photovoltaic panel SP with essentially no delay time. Because a delay is generated when a pyrheliometer and a high-speed pyrheliometer are used, it is difficult to accurately obtain the amount of solar radiation that corresponds to the power output from the PCS 1 at any particular point in time, and it is also difficult, for example, to obtain a true value by correcting a value measured in accordance with the amount of solar radiation. In contrast, if an illumination intensity measured by the illumination intensity sensor 2 of the present embodiment is used, then it is possible to accurately ascertain a relationship between the output from the photovoltaic panel SP and the amount of solar radiation, and it becomes possible to evaluate the true characteristics of a photovoltaic power generation system.

The evaluator 3 is provided with an output acquisition unit 31 that is configured by an ammeter and a voltmeter that are provided as hardware in the PCS 1, and with a computer that performs various types of calculations. As a result of a photovoltaic power generation system evaluation program which is stored in the computer's memory being executed, the evaluator 3 is made to work in collaboration with the various instruments so as to evaluate the photovoltaic power generation system based on the outputs from the PCS 1 and the illumination intensity sensors 2. In addition, in the present embodiment, a structure is employed in which the functions of at least a measurement value temporary storage unit 32, a consistency degree calculation unit 33, and a determination unit 34 are performed by the computer.

The output acquisition unit 31 measures current and voltage via shunts that are provided in the circuitry inside the PCS 1, and also measures the power output from the photovoltaic panels SP. Note that, in the present embodiment, the ammeter and voltmeter forming the output acquisition unit 31 are connected by wire to the evaluator 3, however, it is also possible for the power measurement data to be transmitted wirelessly in the same way as for the illumination intensity sensors 2. Note also that because the PCS 1 is constantly performing control using MPPT control such that the photovoltaic panels SP are operating at the maximum operating point, it can be thought that the value of the power measured by the output acquisition unit 31 is the power at the maximum operating point of the illumination intensity at that point in time.

The measurement value temporary storage unit 32 temporarily stores the measurement data for the power measured by the output acquisition unit 31 as time series data.

The consistency degree calculation unit 33 and the determination unit 34 determine whether or not the power measured by the output acquisition unit 31 satisfies sunlight irradiation conditions that are suitable for making an evaluation, and determines that measurement data for power for which the measurement conditions are satisfied are true values that reflect the true performance.

Namely, the consistency degree calculation unit 33 calculates the degree of consistency between illumination intensity measurement values measured by the plurality of illumination intensity sensors 2. More specifically, the consistency degree calculation unit 33 calculates a degree of consistency which shows, for example, the extent to which the time series data for the illumination intensities output from each illumination intensity sensor 2 are consistent with each other.

In the present embodiment, the consistency degree calculation unit 33 is configured such that, using the illumination intensity data output from one particular illumination intensity sensor 2 as a reference, it calculates differences in the illumination intensity at each time in the illumination intensity data output from the other illumination intensity sensors 2. The illumination intensity difference is calculated so as to show, for example, what percentage difference exists in the illumination intensity between the reference illumination intensity and the other illumination intensities.

The determination unit 34 is configured such that, when the illumination intensity output from the reference illumination intensity sensor 2 satisfies predetermined conditions, and the degree of consistency is within a predetermined permissible range, the determination unit 34 determines that the power measured by the output acquisition unit 31 via the PCS 1 is the true value, and outputs this value as a final result.

In the present embodiment, the determination unit 34 is configured such that it determines that the values in the time series data for the power stored in the measurement value temporary storage unit 32 that were measured when the respective illumination intensity differences were within 1%, which is the permissible illumination intensity difference, are the true values, and outputs this data as the final result. Namely, when substantially no differences exist in the illumination intensities measured by the respective illumination intensity sensors 2, and no unevenness in the illumination intensity is generated on the photovoltaic panels SP, then the determination unit 34 determines that measurement conditions that enable the photovoltaic panels SP to output their proper output are in effect, and the power at such times is determined to be the true value.

The reason why measurement conditions such as these are set by the measurement unit 34 is as follows. Even if illumination intensity sensors 2 having a sufficiently fast response speed in response to changes in the illumination intensity of the sunlight are used, an illumination intensity difference of 1% or more is still sometimes generated. Namely, because the illumination intensity sensors are the same, it is considered that these illumination intensity differences are not generated because of differences in the response speed, but instead reflect unevenness in the illumination intensity of the sunlight on the photovoltaic panels SP that is due to differences in the positions where the respective illumination intensity sensors 2 are located. In addition, the determination unit 34 is configured such that, when the illumination intensity difference is greater than 1%, because the prerequisite conditions for unevenness in the illumination intensity that are required in order to evaluate a photovoltaic cell as stipulated in the JIS (Japanese Industrial Standards) and IEC (International Electrotechnical Commission) have not been satisfied, the determination unit 34 does not employ power that is measured in such measurement conditions in the final result.

Effects of the photovoltaic power generation system evaluation apparatus 100 of the present embodiment which has the above-described structure will now be described.

In the photovoltaic power generation system evaluation apparatus 100 of the present embodiment, because the determination unit 34 is configured such that it determines that the output from each photovoltaic panel SP as measured via the PCS 1 is the true value when the illumination intensity difference measured by each of the illumination intensity sensors 2 is not more than 1%, only the power that was measured when there was substantially no unevenness in the illumination intensity on the photovoltaic panels SP can be output as the final result.

Conventionally, it is considered that sunlight irradiation conditions do not remain constant in a large-scale photovoltaic power generation system that is established outdoors, and an average value of the output obtained over a prolonged period such as one month or the like has been used for the output characteristics. Because of this, conversely, it has been difficult to perform an accurate evaluation. In contrast to this, according to the photovoltaic power generation system evaluation apparatus 100 of the present embodiment, it is possible to acquire the power generated when there is substantially no unevenness in the illumination intensity on the photovoltaic panels SP at, for example, 1 sun irrespective of the weather conditions and the location where the photovoltaic power generation system has been built, and a comparison can be made using the same reference point for different photovoltaic power generation systems.

Moreover, because it is assumed that the PCS 1 is using MPPT control to operate the photovoltaic panels SP such that they are generating power at the maximum operating point, and the values at these times are used, it is not necessary to actually measure the I-V characteristics in order to evaluate performance. Accordingly, there is no need to introduce complex measurement equipment into the photovoltaic power generation system, and neither is there any need to halt power generation in order to measure the I-V characteristics. Accordingly, simply by retrofitting the evaluation apparatus 3 to an existing photovoltaic power generation system, it becomes possible to quantitatively evaluate a power generation performance in measurement conditions prescribed in a variety of Standards.

Moreover, in a conventional method of measuring I-V characteristics which uses a pyrheliometer and a high-speed pyrheliometer, measurement opportunities can only be obtained during periods of bright sunshine when the sunlight is stable over a prolonged period, and it has only been possible to measure I-V characteristics outdoors using sunlight on a few dozen days over the course of a year. In contrast, according to the present embodiment, not only is it possible to evaluate a true power generation performance with a high degree of accuracy, but such measurement opportunities can be obtained on approximately 300 days of the year.

Additional embodiments will now be described.

In the above-described embodiment, four photovoltaic panels SP are measured, however, the number and size of the photovoltaic panels SP are not particularly limited.

In the above-described embodiment, the degree of consistency is calculated based on the illumination intensity difference of each illumination intensity, however, it is also possible to calculate the degree of consistency based on various values such as, for example, the difference from an average value of the respective illumination intensities, or a ratio of the respective illumination intensities. In other words, it is sufficient if the degree of consistency is a value that reflects the offset of each illumination intensity when each illumination intensity is compared.

Moreover, it is also sufficient if a plurality of illumination intensity sensors 2 are provided, and if they are provided so as to correspond to the number and size of the photovoltaic panels SP. Namely, unevenness in the illumination intensity on the photovoltaic panels SP can be evaluated more accurately, and whether or not the measured output is a true value can be determined more accurately by the determination unit 34. Moreover, it is also possible for the response speed of the illumination intensity sensors 2 to be faster than the output from the photovoltaic cells. Furthermore, it is also possible for the illumination intensity sensors 2 to be further provided with a temperature sensor that is used for performing temperature compensation on the illumination intensity or on the measurement values for the power generated by the photovoltaic panels SP. Note that a temperature sensor may also be provided on the surface of the photovoltaic panels SP.

It is also possible for the output acquisition unit 31 to acquire, for example, current and voltage instead of acquiring power.

The determination conditions in the determination unit 34 are not limited to those described in the embodiment, and it is also possible to add other determination conditions to these. The predetermined conditions for the illumination intensity may be set as is appropriate. For example, it is also possible to set stringent conditions such as 1 sun, which is the prerequisite for measuring I-V characteristics, and to only extract the resulting strict characteristics. Moreover, even if the conditions stipulate a stable illumination intensity at 0.8 sun or 0.6 sun or the like, the output from the photovoltaic panels SP can still be evaluated accurately by means of, for example, correction calculation.

More specifically, it is also possible to employ a structure in which the determination unit 34 determines that an output measured by the output acquisition unit is a true value when the respective amounts of change in the illumination intensity measured by the respective illumination intensity sensors 2 within a power-generating period of the photovoltaic panels SP are within a predetermined permissible amount of change. If this type of structure is employed, then if there are large changes in the illumination intensity of the sunlight, outputs such as the power and the like at those times are not employed for the measurement results, so that the accuracy can be improved.

Furthermore, it is also possible to employ a structure in which the determination unit 34 determines that an output from the photovoltaic panels SP measured by the output acquisition unit 31 is a true value when each of the measured illumination intensities is within a permissible illumination intensity range. For example, it is possible to determine that an output from the photovoltaic panels SP is a true value only when the illumination intensities measured by all of the illumination intensity sensors 2 are values in the vicinity of 1 sun. If this type of structure is employed, then data that was measured when an illumination intensity meeting the prerequisite conditions for measurement to be performed was not able to be obtained can be excluded, and it is possible for only reliable values to be considered.

Furthermore, it should be understood that various modifications and combinations may be applied to the present invention insofar as they do not depart from the spirit or scope of the present invention.

### DESCRIPTION OF REFERENCE CHARACTERS

100 . . . Photovoltaic power generation system evaluation apparatus
1 . . . PCS
2 . . . Illumination intensity sensor
21 . . . Casing
22 . . . Photovoltaic cell
3 . . . Evaluator
31 . . . Output acquisition unit
32 . . . Measurement value temporary storage unit
33 . . . Consistency degree calculation unit
34 . . . Determination unit

What is claimed is:

1. A photovoltaic power generation system evaluation apparatus that evaluates a performance of a photovoltaic power generation system that comprises photovoltaic panels which are configured by a plurality of photovoltaic cells, and a PCS (Power Control System) that is connected to the photovoltaic panels and performs MPPT (Maximum Power Point Tracking) control, comprising:
a plurality of illumination intensity sensors that are disposed in the vicinity of the photovoltaic panels; and
an evaluator that is connected wirelessly or by wires to the PCS and to the plurality of illumination intensity sensors, and evaluates the performance of the photovoltaic power generation system based on outputs from each of the PCS and the plurality of illumination intensity sensors, wherein
the evaluator comprises:
an output acquisition unit that acquires an output of the photovoltaic panels from the PCS;
a consistency degree calculation unit that calculates a degree of consistency in illumination intensity measurement values measured by the plurality of illumination intensity sensors; and
a determination unit that, when the degree of consistency is within a predetermined permissible range, determines that the output of the photovoltaic panels acquired by the output acquisition unit is a true value.

2. The photovoltaic power generation system evaluation apparatus according to claim 1, wherein the illumination intensity sensor comprises:
a plurality of photovoltaic cells; and
a wireless communicator that wirelessly transmits the outputs from at least a portion of the plurality of photovoltaic cells to the evaluator.

3. The photovoltaic power generation system evaluation apparatus according to claim 1, wherein
the consistency degree calculation unit is configured such that it calculates as the degree of consistency an illumination intensity difference, which is a difference in the illumination intensity measurement values measured by the plurality of illumination intensity sensors, and
the determination unit is configured such that it determines that an output of the photovoltaic panels acquired by the output acquisition unit is a true value when the illumination intensity difference is not more than a predetermined permissible difference.

4. The photovoltaic power generation system evaluation apparatus according to claim 1, wherein a sampling time of the plurality of illumination intensity sensors is set to not less than 1 millisecond and not more than 100 milliseconds.

5. The photovoltaic power generation system evaluation apparatus according to claim 1, wherein the output acquisition unit is configured by an ammeter and a voltmeter that are provided in the PCS.

6. A photovoltaic power generation system evaluation method for evaluating a performance of a photovoltaic power generation system that comprises photovoltaic panels which are configured by a plurality of photovoltaic cells, and a PCS (Power Control System) that is connected to the photovoltaic panels and performs MPPT (Maximum Power Point Tracking) control, comprising:
an illumination intensity acquisition step in which respective illumination intensities are acquired by a plurality of illumination intensity sensors that are disposed in the vicinity of the photovoltaic panels;
an output acquisition step in which an output of the photovoltaic panels is acquired from the PCS;
a consistency degree calculation step in which a degree of consistency in illumination intensity measurement values measured by the plurality of illumination intensity sensors is calculated; and
a determination step in which, when the degree of consistency is within a predetermined permissible range, it is determined that the output of the photovoltaic panels acquired in the output acquisition step is a true value.

7. A storage medium storing a program for a photovoltaic power generation system evaluation apparatus wherein the program is used in a photovoltaic power generation system evaluation apparatus that evaluates a performance of a photovoltaic power generation system that comprises photovoltaic panels which are configured by a plurality of photovoltaic cells, and a PCS (Power Control System) which is connected to the photovoltaic panels and performs MPPT (Maximum Power Point Tracking) control, and that is provided with: a plurality of illumination intensity sensors that are disposed in the vicinity of the photovoltaic panels; and an evaluator that is connected either wirelessly or via wires to the PCS and to the plurality of illumination intensity sensors, and evaluates the performance of the photovoltaic power generation system based on outputs from each of these, and wherein
the program causes functions of a consistency degree calculation unit that calculates a degree of consistency in illumination intensity measurement values measured by the plurality of illumination intensity sensors; and functions of a determination unit that, when the degree of consistency is within a predetermined permissible range, determines that the output of the photovoltaic panels acquired by the output acquisition unit is a true value to be performed by a computer.
